(19) United States
(12) Patent Application Publication
(10) Pub. No.: US 2005/0059812 A1
(43) Pub. Date: Mar. 17, 2005

(54) Process for insertion of acrylonitrile into a metal-carbon bond

(76) Inventors: Thomas Weiss, Mannheim (DE); Richard Jordan, Chicago, IL (US); Bernhard Rieger, Oberelchingen (DE); Claudia Piefer, Langenau (DE)

Correspondence Address: LANXESS CORPORATION;PATENT DEPARTMENT/ BLDG 14, 100 BAYER ROAD, PITTSBURGH, PA, 15205-9741, US

(21) Appl. No.: 10/919,722

(22) Filed: Aug. 16, 2004

(30) Foreign Application Priority Data
Sep. 15, 2003 (DE) 10342571.3

(51) Int. Cl. C07F 15/00; C07F 9/02

(52) U.S. Cl. 534/691; 556/18

(57) ABSTRACT

The present invention relates to compounds with a metal-carbon bond suitable for insertion of acrylonitrile, a process for the preparation of these compounds and the use of these compounds for further insertions of acrylonitrile and/or other monomers.

### FIELD OF THE INVENTION

The present invention relates to compounds with a metal-carbon bond suitable for insertion of acrylonitrile, a process for the preparation of these compounds and the use of these compounds for further insertions of acrylonitrile and/or other monomers.

### BACKGROUND OF THE INVENTION

There is a great interest in polymerization also of polar monomers by “coordinative polymerization” with other polar and/or non-polar monomers.

Non-polar monomers are to be understood as meaning all monomers which contain exclusively carbon and hydrogen. All other monomers which carry further atoms or additional substituents or exclusively those substituents which are not pure hydrocarbons are to be understood as polar monomers in the context of the present invention.

The C—C linkage which arises during coordinative polymerization can be explained by the Cossee-Arlmann mechanism, or more precisely by the modified Green-Arlmann mechanism as described in Equation 1 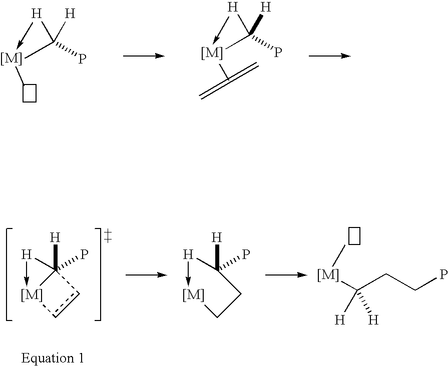
and in Acc. Chem. Rev. 1996, 29, 85 by Grubbs and Coates. In this equation [M] represents the metal atom of the catalyst, P represents the growing polymer chain and □ represents the free coordination site on the central atom.

The succession of such reaction sequences is summarized as insertion of the olefin into a metal-carbon bond, where the “coordinative polymerization” as such can be described by sequential stringing together of a large number of insertion steps.

The succession of insertions is usually prevented by polar monomers, since the polar function of the olefins blocks the free coordination site on the metal center, as shown by the example of acrylonitrle in Equation 2 and described in J. Organomet. Chem. 2002, 654 (1-2), 132-139 by Bhaduri, Mukhopadhyay and Kulkarni and by Deubel and Ziegler in Organometallics 2002, 21(8), 1603-1611 and in Organometallics 2002, 21(8) in press. Equation 2, termination):

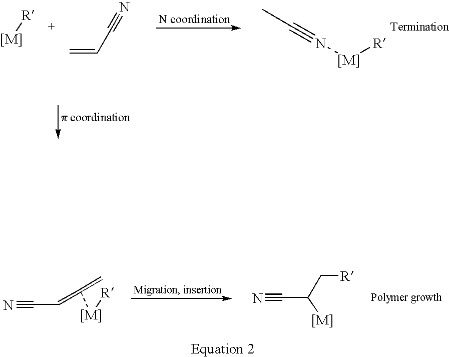

In this equation [M] represents the metal atom of the polymerization catalyst, R′ represents a substituent which both can be chosen from the group consisting of substituted and unsubstituted alkyl and aryl groups and also can be a polymer chain which has already grown and N represents the nitrogen atom of the acrylonitrile employed.

When polar monomers were employed, there was the opinion that the polar center of the monomer coordinates on to the metal center, so that a further insertion or a chain growth in the sense of a “coordinative polymerization” is not possible. A π coordination of a polar monomer such as acrylonitrile on to a complex which also contains a metal-carbon bond has already been described by Albano and Castellari in Organometallics 1990, 9, 1269. However, a subsequent insertion of the acrylonitrile into the metal-carbon bond and further insertions into the metal-α-cyanomethylidene bond formed have not been observed.

In J. Am. Chem. Soc. 2002, 124, 9330, Hartwig-and Culkin describe nitrile-bridged, coordination-polymeric structures which, however, are not formed by an insertion into a metal-carbon bond and have another ligand environment around the metal center, and which are not suitable for further insertions of other monomers. Di-, tri- or polymeric complexes or mixtures of these are not disclosed by Hartwig and Culkin.

Accordingly, the present invention provides compounds which have been prepared by an insertion of acrylonitrile-into a metal-carbon bond and which render possible one or more further insertions of acrylonitrile or other monomers.

The present invention is further directed to the preparation of novel, tailor-made (co)polymers by suitable monomer combinations, the catalysts and cocatalysts used influencing the incorporation of the monomers.

### SUMMARY OF THE INVENTION

The present invention is directed to compounds of the formula (I) 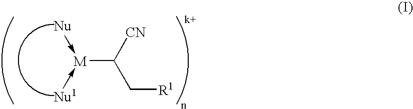
in which
M is an element of the 4th to 12th group of the periodic table,
Nu is chosen from —P(R)₂, —N═P(R), —N═N(R), —C(R²)═P(R) and —C(R²)—N(R), wherein the coordination to M always starts from the atom which carries the substituent R, and
   R is chosen from hydrogen and C₁-C₂₄ substituted or unsubstituted hydrocarbon radicals, which can also carry further heteroatoms, and wherein R can also form a ring with ∩, with R² or with the atom of Nu which does not form a coordinative bond to M,
   R² is chosen from hydrogen and C₁-C₂₄ substituted or unsubstituted hydrocarbon radicals
Nu² is chosen from —O—, =N(R³) and ═P(R³), wherein in the case where Nu¹ is —O—, instead of a coordinative bond a covalent bond to M is formed,
R³ is chosen from hydrogen and C₁-C₂₄ substituted or unsubstituted hydrocarbon radicals, which can also carry further heteroatoms, and wherein R³ can also form a ring with r) or with the atom of Nu¹ adjacent to the double bond,
R¹ is chosen from C₁-C₂₄ substituted or unsubstituted hydrocarbon radicals or a polymer chain, wherein the polymer chain is built up from recurring units derived from ethylene, propylene, styrene, carbon monoxide, 1,3-butadiene, acrylates, acrylonitrile or mixtures of these monomers, and
n is an integer between 1 and 100, wherein for n=1 a donor compound D chosen from the group consisting of neutral donor compounds can stabilize the metal center, and
k is an integer between 0 and 100 and only in the case where Nu¹ is —O— is k=0,
∩ is a hydrocarbon group which in each case independently of one another forms a covalent single or multiple bond to Nu and to Nu¹, wherein both the bond to Nu and to Nu¹ are formed either from the same C atom of the hydrocarbon group or from two different C atoms of the hydrocarbon group, and wherein the hydrocarbon group is derived from alkyl, cycloalkyl, aryl, aralkyl and alkylaryl units and mixtures of these units, wherein the hydrocarbon group can also carry further heteroatoms.

The present invention also provides a process for the preparation of the compounds of the formula (I) including the steps of
a) providing compounds of the formula (II) 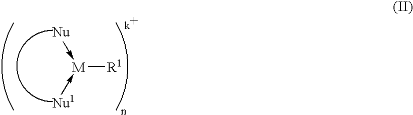
in which Nu, Nu¹, M, R¹, ∩, n and k have the same meaning as explained above and
   b) reacting compounds of the formula (II) with acrylonitrile in the temperature range from −200 to +200° C.

### BRIEF DESCRIPTION OF THE DRAWINGS

FIG. 1 illustrates the X-ray structure analysis of the trimerization product of the 2,1 insertion of the acrylonitrile into the palladium-α-methylidene bond.

### DETAILED DESCRIPTION OF THE INVENTION

The process for the preparation of the compounds of the formula (I) according to the present invention wherein the reaction of the compound of the formula (II) with acrylonitrile preferably includes the following steps:
a) reacting compounds of the formula (II) with acrylonitrile in a temperature range from −200 to +200° C. in the presence of an organic solvent to form the compounds of the formula (III) 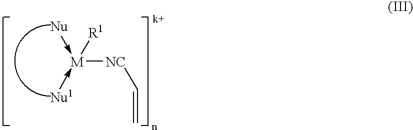
wherein
   Nu, Nu¹, M, R¹, ∩, n and k have the same meaning as explained above, and subsequently removing the solvent,
b) reacting compounds of the formula (III) with acrylonitrile at a temperature in the range from −200 to +200° C. in the presence of an organic solvent and
c) monitoring the time-dependent NMR spectroscopy of the conversion of the compounds of the formula (III) into the compounds of the formula (I) and subsequently removing the solvent.

The present invention also provides the use of the compounds of the formula (I) according to the present invention for the preparation of complexes of the formula (IV) 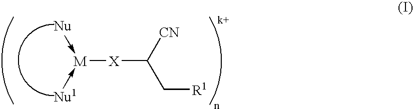
wherein
Nu, Nu¹, M, R¹, ∩, n and k have the same meaning as explained above and the recurring unit X is derived from one or more monomers chosen from the group consisting of carbon monoxide, ethene, 1,3-butadiene, styrol, 1-olefins, acrylonitrile, methacrylonitrile, fumaric acid dinitrile, alkyl acrylates, acrylic acid, sodium acrylate, fumaric acid, fumaric acid esters, maleic acid, maleic acid esters, maleic anhydride, alkyl vinyl ethers and mixtures of these monomers.

In the compounds of the formula (I) 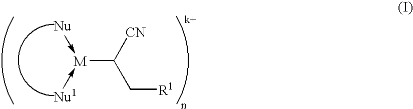
M represents an element of the 4th to 12th group of the periodic table, the elements from the 8th group are preferred, Ni, Pd. Pt, Co, Fe and Ru are more preferred, and Ni and Pd are most preferred.

Further ligands Nu and Nu¹ are bonded to the meal atom. Nu is chosen from —P(R)₂, —N═P(R), —N═N(R), —C(R²)═P(R) and —C(R²)═N(R), wherein the coordination to the metal atom M always starts from the atom which carries the substituent R. —C(R²)═N(R) and —N═N(R) are preferred.

The substituent R is chosen from hydrogen and C₁-C₂₄ substituted or unsubstituted hydrocarbon radicals, which can also additionally carry further heteroatoms, and wherein R can also form a ring with ∩ or with the atom of Nu which does not form a coordinative bond to M.

C₁-C₂₄ substituted or unsubstituted hydrocarbon radicals are to be understood as meaning all hydrocarbon radicals which can contain 1 to 24 C atoms and optionally further heteroatoms. Substituted or unsubstituted C₁-C₈-alkyl, substituted or unsubstituted C₃-C₈-cycloalkyl, substituted or unsubstituted C₂-Cg-alkenyl, substituted or unsubstituted C₆-C₁₄-aryl, substituted or unsubstituted C₇-C₂₄-aralkyl and substituted or unsubstituted C₇-C₂₄-alkylaryl groups, wherein each group can also carry further heteroatoms, are preferred.

Preferred unsubstituted C₁-C₈-alkyl groups which carry no further heteroatoms include methyl, ethyl, n-propyl, i-propyl, n-butyl, i-butyl, sec-butyl, tert-butyl and n-pentyl. Ethyl, i-propyl, n-butyl and tert-butyl are preferred.

Preferred substituents of the substituted C₁-C₈-alkyl groups, wherein these carry no further heteroatoms, include C₁-C₈-alkyl, C₃-C₈ cycloalkyl and C₆-C₁₄ aryl groups.

Preferred unsubstituted C₃-C₈ cycloalkyl groups which carry no further heteroatoms include cyclopropyl, cyclobutyl, cyclopentyl, cyclohexyl, cycloheptyl, cyclooctyl, cyclononyl, cyclodecyl and cycloundecyl. Cyclopropyl, cyclobutyl, cyclopentyl and cyclohexyl are preferred. Preferred substituents of the substituted C₃-C₈-cycloalkyl groups, wherein these carry no further heteroatoms, include C₁-C₈-alkyl, C₃-C₈-cycloalkyl and C₆-C₁₄-aryl groups.

Preferred unsubstituted C₂-C₈ alkenyl groups which carry no further heteroatoms include vinyl, 1-allyl, 3-allyl, ω-butenyl, ω-pentenyl and (o-hexenyl. Vinyl, 1-allyl and 3-allyl are preferred. Preferred substituents of the substituted C₂-C₈-alkenyl groups, wherein these carry no further heteroatoms, include C₁-C₈-alkyl, C₃-C₈-cycloalkyl and C₆-C₁₄-aryl groups.

Preferred unsubstituted C₆-C₁₄-aryl groups which carry no further heteroatoms include phenyl, 1-naphthyl, 2-naphthyl, 1-anthryl, 2-anthryl, 9-anthryl and acenaphthyl. Phenyl and 1-naphthyl are preferred.

Preferred substituents of the substituted C₆-C₁₄ aryl groups, wherein these carry no further heteroatoms, include C₁-C₈-alkyl, C₃-C₈-cycloalkyl and C₆-C₁₄-aryl groups.

Preferred unsubstituted C₇-C₂₄-aralkyl groups which carry no further heteroatoms include benzyl, 1-phenethyl, 2-phenethyl, 1-phenyl-propyl, 2-phenyl-propyl, 3-phenyl-propyl, 1-naphthyl-methyl and 2-naphthyl-methyl. Benzyl is preferred.

Preferred substituents of the substituted C₇-C₂₄-aryl groups, wherein these carry no further heteroatoms, include C₁-C₈-alkyl, C₃-C₈-cycloalkyl and C₆-C₁₄-aryl groups.

Preferred unsubstituted C₇-C₂₄-alkylaryl groups which carry no further heteroatoms include substituents of the unsubstituted C₇-C₂₄-aralkyl groups which carry no further heteroatoms.

Preferred substituents of the substituted C₇-C₂₄-alkylaryl groups, wherein these carry no further heteroatoms, include substituents of the substituted C₇-C₂₄-aralkyl groups.

The substituted and/or unsubstituted C₁-C₂₄-hydrocarbon radicals can also carry further heteroatoms. The heteroatoms include nitrogen, phosphorus, oxygen and sulfur. Nitrogen, oxygen and sulfur are preferred.

Preferred unsubstituted C₁-C₈-alkyl groups which also contain one or more heteroatoms include halogenoalkyl, thiols, amines, ethers, thioethers, alcohols, aldehydes, esters, imines, nitriles, carboxylic acids and amides and amino acids, having 1 to 8 C atoms.

Preferred substituted C₁-C₈-alkyl groups which also contain one or more heteroatoms include chloromethyl, dichloromethyl, trichloromethyl, 1,2-dichloroethyl, 1,1-dichloroethyl, 1,1′,2,2′-tetrachloroethyl, cyanomethyl, dicyanomethyl, aminomethyl, formyl, acetyl, methylsulfide, methoxy, ethoxy, i-propoxy, glycinimine and alaninimine.

Preferred unsubstituted C₃-C₈ cycloalkyl groups which also contain one or more heteroatoms include morpholines, cyclic ethers, cyclic amines, cyclic thioethers, lactams, lactones and heteroatom-substituted C₃-C₈-cycloalkanes with substituents such as halogenoalkyl, nitrile, alcohol, thiol, amino, carboxylic acid, esters and amides.

Preferred substituted C₃-C₈-cycloalkyl groups which also contain one or more heteroatoms include morpholine, tetrahydrofuran, pyran, dioxane, tetrahydrothiophene, pyrrolidine, piperidine, butyrolactam, butyrolactone, caprolactam, caprolactone, cyclohexanone, cyclopentanone and tropone.

Preferred unsubstituted C₂-C₈-alkenyl groups which also contain one or more heteroatoms include halogenoalkenyl, thiols, amines, ethers, thioethers, alcohols, aldehydes, esters, imines, lactams, nitriles, carboxylic acids and amides.

Preferred substituted C₂-C₈-alkenyl groups which also contain one or more heteroatoms include 1,1′-dichloroethylene, 1,1′-dicyanoethylene, vinylpyrrolidone, acrylic acid, crotonic acid, methacrylic acid, acrylic acid methyl ester, crotonic acid methyl ester, methacrylic acid methyl ester, vinyl acetate, acrylonitrile, crotonitrile, methacrylonitrile, ketenes, ketimines, 1,1′-dichloroallenyl, vinyl ethers, such as vinyl methyl ether and vinyl ethyl ether, and vinylaldehydes, such as acrolein, crotonaldehyde and methacrylaldehyde.

Preferred unsubstituted C₆-C₁₄-aryl groups which also contain one or more heteroatoms include halogenoaryl, thiols, amines, ethers, thioethers, alcohols, aldehydes, esters, imines, nitriles, carboxylic acids and amides.

Preferred substituted C₆-C₁₄-aryl groups which also contain one or more heteroatoms include furan, pyran, quinoline, isoquinoline, pyrazole, imidazole, pyridine and thiophene.

Preferred unsubstituted C₇-C₂₄-aralkyl or alkylaryl groups which also contain one or more heteroatoms include halogeno-aralkyl, thiols, amines, ethers, thioethers, alcohols, aldehydes, esters, imines, nitriles, carboxylic acids and amides.

Preferred substituted C₇-C₂₄-aralkyl or alkyl groups which also contain one or more heteroatoms include methylpyri-dines, N-miethylpyridine, N-methylpyrazole, methylthiophenes, methylquinolines, N-methylquinolines, methylimidazoles, N-methylimidazoles, ethylpyridines, N-ethylpyridine, N-ethylpyrazole, ethylthiophenes, ethylquinolines, N-ethylquino-lines, ethylimidazoles and N-ethylimidazoles.

The substituent R can form a ring either with ∩ or with R² or with the atom of Nu which does not form a coordinative bond to M.

R preferably forms ring systems with ∩ such that the ring system thereby formed preferably contains between 1 to 5 C atoms. Ring systems which are five- or six-membered are preferred.

If R forms a ring system with R² or with the atom of Nu which does not form a coordinative bond to M, these can all be aromatic and unsaturated five- or six-membered ring systems. These ring systems preferably include imidazoles, pyrazoles, thiazoles, oxazoles, thiadiazoles, oxadiazoles, pyrimidines, phospholes, quinolines and pyridines.

If R² forms no ring system With R, R² is chosen from hydrogen and substituted and/or unsubstituted C₁-C₂₄-hydrocarbons, which can optionally also carry heteroatoms.

In addition to Nu, a further nucleophile Nu¹ is also bonded to the metal center. Nu¹ is chosen from —O—, ═N(R³) and ═P(R³). Only in the case where Nu¹ is oxygen does this form a covalent bond to the metal atom M. For the groups ═N(R³) and ═P(R³), coordinative bonds to M are formed.

R³ is chosen from hydrogen and substituted and/or unsubstituted C₁-C₂₄ hydrocarbons, wherein R³ can also form a ring with ∩ or with the atom of Nu¹ adjacent to the double bond.

R³ preferably forms with ∩ those ring systems which contain between 1 to 5 C atoms. Ring systems which are five- or six-membered are preferred.

If R³ forms a ring system with the atom of Nu¹ adjacent to the double bond, these can all be aromatic and unsaturated C₅-C₁₄ ring systems. These ring systems are preferably chosen from imidazoles, pyrazoles, thiazoles, oxazoles, thiadiazoles, oxadiazoles, pyrimidines, phospholes, quinolines and pyridines.

R¹ is chosen from C₁-C₂₄ substituted or unsubstituted hydrocarbon radicals and a polymer chain, wherein the polymer chain is built up from recurring units derived from ethylene, propylene, styrene, carbon monoxide, 1,3-butadiene, ethylidene-norbornene, acrylates, acrylonitrile or mixtures of these monomers.

Preferred substituted or unsubstituted C₁-C₂₄-hydrocarbon radicals are the abovementioned substituted and unsubstituted C₁-C₈-alkyl groups. More preferred substituted or unsubstituted C₁-C₈-alkyl groups are methyl, ethyl, n-propyl, i-propyl, n-butyl, t-butyl and neo-pentyl. The preferred polymer chain includes recurring units derived from ethylene, acrylonitrile, 1,3-butadiene, ethylidenenorbornene or mixtures of these monomers. A polymer chain which contains recurring units derived from ethylene and acrylonitrile is more preferred. In this context, these recurring units can be built up both randomly and in block form.

The number n indicates how often the structural units of the compounds of the formula (I), (II), (III) and (IV) which are shown in parentheses occur. n is preferably an integer in the range from 1 to 100, more preferably in the range from 1 to 3.

In the case where n=1, the metal center M of the compounds of the formula (I) can be stabilized with further donor compounds D.

Donor compounds D are understood as meaning all neutrally charged compounds which can stabilize the metal center with free electron pairs. Preferred donor compounds include triarylphos-phines, such as triphenylphosphine, trialkylphosphines, such as tris-t-butylphos-phine, trimethylphosphine and triethylphosphine, pyridines, quinolines, tertiary amines, such as trimethylamine, triethylamine, triisopropylamine and dimethyl-benzylamine, carbon monoxide, ethene, acrylates, such as methyl acrylate, ethyl acrylate and butyl acrylate, acrylonitrile and unsaturated π acids, such as ethene, 1-olefins and 1-olefins with polar or non-polar substituents, and also aromatics. Non-polar 1-olefins are to be understood as meaning all 1-olefins which are substituted by hydrogen, alkyl groups or aryl groups. All other 1-olefins which carry additional substituents or exclusively those substituents which do not belong to the group consisting of hydrogen and alkyl and aryl groups are to be understood as polar 1-olefins in the context of the present invention. Preferred donor compounds D are chosen from the group consisting of propene, butene, styrene, vinyl chloride, acrylonitrile, methacrylonitrile, fumaric acid nitrile, methyl acrylates, ethyl acrylates, methyl vinyl ether, ethyl vinyl ether, silyl vinyl ether, phosphines, pyridines and aromatics, such as benzene, toluene or naphthalene.

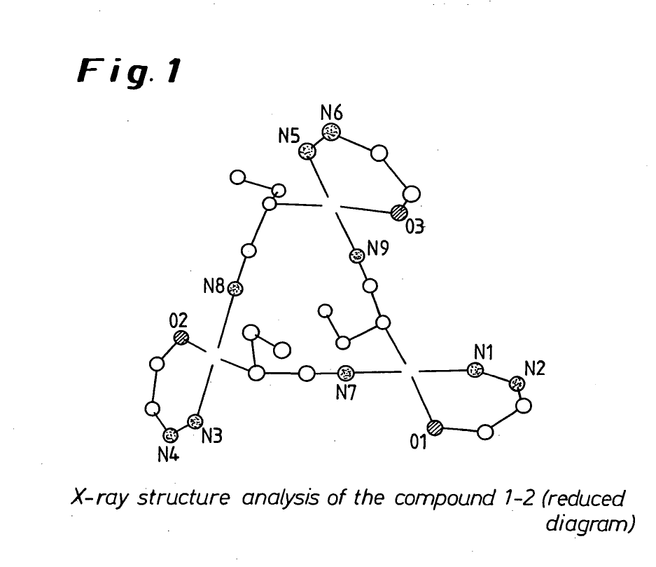

FIG. 1 shows the X-ray structure analysis of a compound of the formula (I) (example 1, compound 1-2), in which n=3. The compound therefore contains the structural unit in parentheses in the compounds of the formula (I) three times. Pd1, Pd2 and Pd3 in this context are the palladium center, O1, O2 and O3 are the oxygen of the three structural units, wherein N1, N2 and N9 represent the nitrogen atoms which belong to the first structural unit, N3, N4 and N7 represent the nitrogen atoms which belong to the second structural unit and N5, N6 and N8 represent the nitrogen atoms which belong to the third structural unit. N7, N8 and N9 are in each case the nitrogen atoms which originate from the nitrile group of the acrylonitrile inserted. All the other spheres represent carbon centers. The hydrogen centers are absent in this diagram in order to be able to show a clearer structure.

The number k indicates whether and how the compounds of the formula (I), (II), (D) and (IV) are charged. Only in the case where Nu¹ is oxygen is a covalent bond formed between the metal center M and Nu¹. In this case k=0. For all other cases k is an integer in the range from 1 to 100. k is preferably an integer in the range from 1 to 10.

The two nucleophilic radicals Nu and Nu¹ are bonded to one another via ∩. ∩ is to be understood as meaning hydrocarbon groups which in each case independently of one another form a covalent single or multiple bond to Nu and to Nu¹, wherein both the bond to Nu and to Nu¹ are formed either form the same C atom of the hydrocarbon group or from two different C atoms of the hydrocarbon group, and wherein the hydrocarbon group is derived from alkyl, cycloalkyl, aryl, aralkyl and alkylaryl units and mixtures of these units, wherein the hydrocarbon group can also carry further heteroatoms.

Preferred units which contain no further heteroatoms are chosen from methylidene, ethylidene, propylidene, butylidene, 1,2-phenylidene and 1-methylidene-phen-2-yl.

The heteroatoms which can be contained in ∩ are chosen from nitrogen, sulfur, oxygen, phosphorus, silicon and tin, preferably nitrogen, sulfur and oxygen. Preferred units for ∩ which furthermore contain heteroatoms are chosen from methylidene, ethylidene, propylidene, butylidene, 1,2-phenylidene and 1-methylidene-phen-2-yl.

For the preparation of the compounds of the formula (I), compounds of the formula (II) 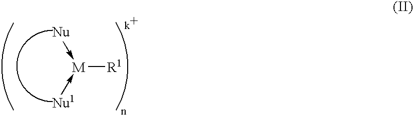
are reacted with acrylonitrile in a temperature range from −200 to +200° C.

The reaction is preferably carried out in the presence of a solvent. Solvents are to be understood as meaning all the organic solvents known to those skilled in the art. The solvents are preferably chosen from toluene, hexane, pentane, methylene chloride, tetrahydrofuran, diethyl ether and acrylonitrile. Acrylonitrile and hexane are more preferred.

The reaction of polar and non polar functionalized 1-olefins with the compounds of the formula (II) can proceed in the form of a 1, 2 or 2,1 insertion step, depending on the preference of the olefins for the catalyst center. Non-polar 1-olefins are to be understood as meaning all 1-olefins which are substituted by hydrogen, alkyl groups or aryl groups. All other 1-olefins which carry additional substituents or exclusively those substituents which do not belong to the group consisting of hydrogen and alkyl and aryl groups are to be understood as polar 1-olefins in the context of the present invention.

The reaction of acrylonitrile with the compounds of the formula (II) takes place by a 2,1 insertion of the acrylonitrile into the metal-carbon bond (M-R¹).

Preferably, the compounds of the formula (II) are reacted with acrylonitrile in the temperature range from −200 to −60° C. and in the presence of an organic solvent to form the compounds of the formula (M) 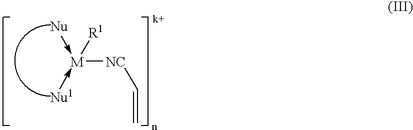
and excess solvent is then removed. The compounds of the formula (III) are then preferably reacted again with acrylomtrile at temperatures in the range from −20 to 200° C., preferably in the range from 25 to 80° C. The conversion of compounds of the formula (III) into compounds of the formula (I) is monitored by means of time-dependent NMR spectroscopy analyses. When conversion is complete, the excess solvent is removed. The compounds of the formula (I) can be obtained by the purification processes known to the expert. Preferred purification processes are low temperature crystallization and chromatographic processes.

The compounds of the formula (I) according to the present invention are also used for the preparation of complexes of the formula (IV)

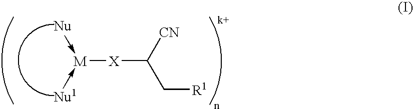

For the preparation of the complexes of the formula (IV), the compounds of the formula (I) are reacted with monomers chosen from carbon monoxide, 1-olefins, acrylonitrile, methacrylonitrile, fumaric acid dinitrile, alkyl acrylates, acrylic acid, sodium acrylate, fumaric acid, fumaric acid esters, maleic acid, maleic acid esters, maleic anhydride, alkyl vinyl ethers and mixtures of these monomers. Preferred 1-olefins are ethene, propene, 1-butene, 1-pentene, 1-hexene, 1-heptene, 1-octene, 1-nonene, 1-decene, 1,3-butadiene and ethylidenenorbornene. Preferred acrylates are methyl acrylate, ethyl acrylate, propyl acrylate, butyl acrylate, pentyl acrylate and hexyl acrylate. The preferred alkyl vinyl ether is ethyl vinyl ether.

The insertion of carbon monoxide or other monomers X into the metal-α-cyanomethylidene bond is preferably carried out under pressure. Pressures in the range from 1 to 50 bar are preferred, more preferably in the range from 1 to 20. Carbon monoxide pressures in the range from 0.1 to 100 bar, preferably in the range from 5 to 50 bar, are suitable for the insertion of carbon monoxide.

The compounds according to the present invention render possible, after the insertion of acrylonitrile, a further insertion step without the free coordination site on the metal center being blocked for further following insertion steps, so that a copolymer, obtained by coordinative polymerization, of recurring units derived from acrylonitrile and one or more other monomers can be accessed not only via free-radical polymerization.

The following examples illustrate the inventions claimed:

### EXAMPLES

Experimental Part

### Example 1

Direct synthesis of linear ethylene/acrylonitrile copolymers by-insertion polymerization on metal catalysts was desired. New catalysts, based on late transition metals, which are tolerant towards the —CN groups of acrylonitrile monomer and the growing copolymer chain were developed. Investigations of the reaction of a Pd-ethylene dimerization catalyst with acrylonitrile provided new findings regarding the influence of the presence of CN substituents on the monomer and of the growing alkyl chain on the structures and the reactivity of LₙM(R)(substrate)⁺ species in olefin polymerization systems are described. The 2,1 insertion of acrylonitrile into a Pd—Me bond and the reversible CO insertion into the resulting Pd—CH(CN)CH₂CH₃ bond are described.

The reaction steps are summarized in equations 1 and 2. The reaction of (bim)PdMe₂ (1) (bim CH₂(N-Me-imidazole)₂) with 1 equiv. [HNMe₂Ph][B(C₆F₅)₄] by a process described by Burns et al. Abstracts of Papers, 224th ACS National Meeting, Boston 2002, INOR 322 was performed and gave [(bim)PdMe(NMe₂Ph)][B(C₆F₅)₄] (2) and methane quantitatively in the course of 10 min at −78° C. According to the NMR spectra of 2, an unsymmetric bim ligand and coordinated NMe₂Ph were present. In the ¹H-NMR spectrum, one of the imidazole-H4 resonances showed a high-field shift (δ 4.98), which was attributed to the anisotropic shielding by the NMe₂Ph phenyl ring. The complex 2 was stable at −40° C. in CD₂Cl₂, but decomposed at 23° C. in the course of 10 min. The complex 2 catalized the dimerization of ethylene, as described by Albietz, P. J. Jr.; Yang, K.; Lachicotte, R. J.; Eisenberg, R. Organometallics 2000, 19, 3543 and by Yang, Z.; Ebihara, M.; Kawamura, T. J. Mol. Catal. A: Chemical 2000, 158, 509 and by Chin, C. K.; Chong, D.; Lee, S.; Park, Y. J. Organometallics, 2000, 19, 4043 and by Davidson, J. L.; Ritchtzenhein, H.; Thiebaut, B. J. S.; Landskron, K.; Rosair, G. M. J. Organomet. Chem. 1999, 592, 168.

The addition of an excess of acrylonitrile (AN) to 2 at −60° C. lead in the course of 5 min to the quantitative displacement of NMe₂Ph and to the formation of the AN complex (bim)Pd(Me)(NCCH═CH₂)⁺ (3). The ¹H-NMR spectrum of 3 at −60° C. contained resonances for coordinated AN at δ 6.55 (d, J=17.9, 1H, Hₜᵣₐₙₛ), 6.43 (d, J=12.0, 1H, H_{cis}) and 5.93 (dd, J=17.9, 12.0, 1H, Hᵢₙₜ), which showed a low-field shift by approx. 0.3 ppm with respect to the resonances of free AN (δ 6.24 (d, J=17.9, 1H, Hₜᵣₐₙₛ), 6.09 (d, J=12.0, 1H, H_{cis}), 5.69(dd, J=17.9, 12.0, 1H, Hᵢₙₜ)). The ¹³C-NMR spectrum of 3 contained resonances for coordinated AN at δ 143.0 (Cₜₑᵣ), 119.2 (CN) and 105.7 (Cᵢₙₜ), which showed only a slight shift with respect to the values for free AN (δ 138.1 (Cₜₑᵣ), 117.3 (CN) and 107.2 (Cᵢₙₜ)). These data for 3 had a marked similarity with data for known N-bonded AN complexes, such as [LPt(Me)(NCCH═CH₂)]BF₄ (L=(2-OSiⁱPr₃-6-Me-phenyl)N═CHC(H)=N(2-OSiⁱPr3-6-Me-phenyl)) (¹H-NMR δ 6.27 (d, J=18, Hₜᵣₐₙₛ), 5.97 (d, J=12, H_{cis}) and 5.52 (dd, J 18, 12, Hᵢₙₜ); ¹³C-NMR δ 142 (Cₜₑᵣ), 118 (CN) and 105 (Cᵢₙₜ)).¹ In contrast to this, the ¹H- and ¹³C-NMR resonances of AN in π complexes usually showed far high-field shifts with respect to the values for free AN, such as e.g. in {P(O-o-tolyl)₃}₂Ni(η²-CC—CH₂═CHCN) (¹H-NMR δ 1.28 (1H, Hₜᵣₐₙₛ, 1.17 (1H, H_{cis}) and 1.69 (1H, Hᵢₙₜ); ¹³C-NMR δ 42.7 (s, Cₜₑᵣ) and 25.9 (s, Cᵢₙₜ)), and as described by Tolman, C. A.; Seidel, W. C. in J. Am. Chem. Soc. 1974, 96, 2774 and by Albano, V. G.; Castellari, C. in Organometallics 1990, 9, 1269 and by Maekawa, M.; Munakata, M.; Kuroda-Sowa, T.; Hachiya, K. in Inorg. Chim. Acta 1994, 227, 137 and by Seligson, A. L.; Trogler, W. C. in Organometallics, 1993, 12, 744. It was concluded from this that 3 contained an N-bonded AN ligand. The complex 3 was stable at −60° C., but reacted further at temperatures above −10° C.

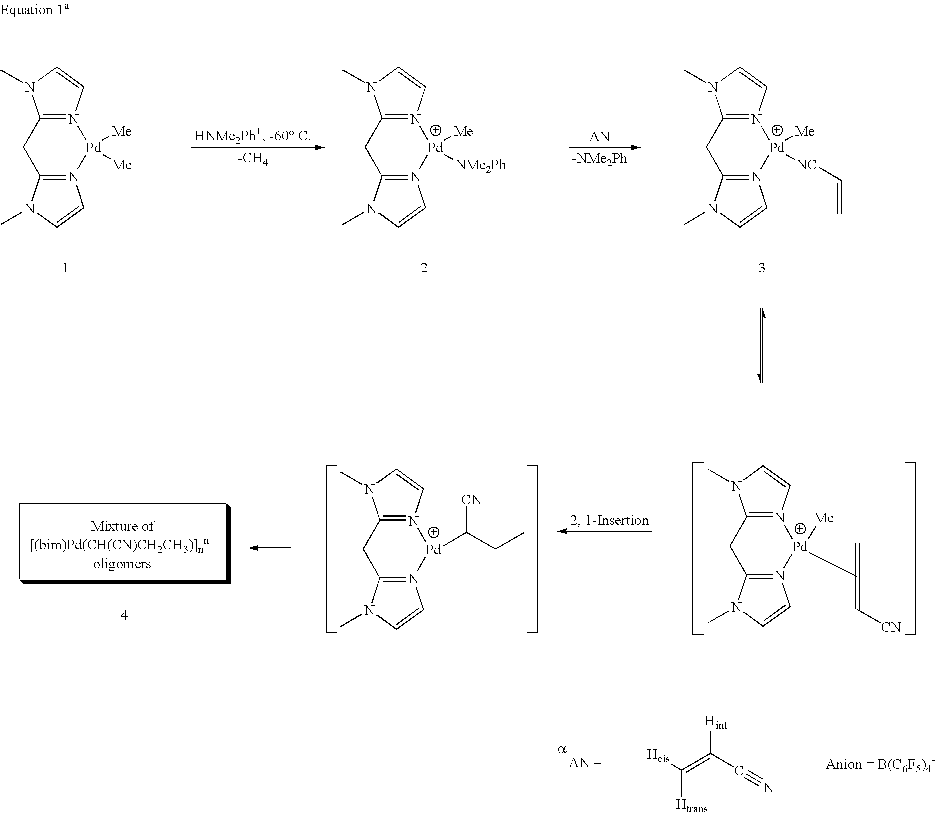

The (bim)Pd(Me)(NCCH═CH₂)⁺ cation 3 reacted completely in the course of 12 h at 23° C. with 2,1 insertion of the C═C bond of AN to give (bim)Pd{CH(CN)CH₂CH₃}⁺, which was formed as a mixture of oligomeric [(bim)Pd{CH(CN)CH₂CH₃}]ₙⁿ⁺ species (4) in a yield of 90%. (According to ¹H-NMR and ESI-MS analysis, the remaining 10% of the product was the dicationic bis-ligand complex (bim)₂Pd²⁺, ¹H-NMR (CD₂Cl₂): δ 7.05 (d, J=1.8, 4H, imidazole-H), 6.63 (d, J=1.8, 4H, imidazole-H), 4.39 (s, 4H, CH₂), 3.84 (s, 12H, imidazole-N-Me). ESI-MS: (bim)₂Pd²⁺ calculated: m/z 229.1, found 228.9.) Monitoring of the reaction by means of ¹H-NMR showed that 3 was consumed completely, but no free AN was consumed in this reaction. The ¹H-NMR spectrum of the oligomer mixture 4 contained three sets of doublets, which were characteristic of unsymmetric (bim)Pd surroundings, and a complicated set of alkyl resonances. The ESI-MS analysis showed that three main cations were present, the molecular weights and isotope patterns of which corresponded to [(bim)Pd{CH(CN)CH₂CH₃}ₙⁿ⁺ (n=1, 2, 3). The compound 4 was stable in CD₂Cl₂ solution at 23° C. for at least 10 days.

Oligomeric [(bim)Pd{CH(CN)CH₂CH₃}]ₙⁿ⁺ (4) was not converted into monomeric (bim)Pd{CH(CN)CH₂CH₃}(L)⁺ species by the addition of an excess of CH₃CN, THF or ethylene at 23° C. However, as can be seen from equation 2, 4 reacted quantitatively in the course of 5 min at 23° C. with 1 equiv. PPh₃ to give the monomeric cation (bim)Pd{CH(CN)CH₂CH₃}(PPh₃)⁺ (5), which was characterized by multinuclear NMR and ESI-MS. The ¹H-NMR spectrum of 5 contained a set of resonances in the alkyl range, which was diagnostic for the α-cyanopropyl ligand and which demonstrated the 2,1 insertion regiochemistry in equation 1. The PdCH(CN)Et-methine resonance appeared, due to the coupling with the two methylene protons and the phosphorus, at δ 1.72 as ddd (J_{HH}=12.9, 8.5; J_{HP}=6.9), and the ethyl resonances appeared at δ 1.31 (m, CH₂), 1.28 (m, CH₂) and δ 0.67 (t, CH₃). The ¹³C{¹H} resonance of the PdCH(CN)Et methine appeared as a doublet (J_{CP}=4) at δ 13.2. The ³¹P-NMR spectrum contains a resonance at δ 35.1 for the PPh₃ ligand, which showed a low-field shift with respect to the position of free PPh₃ (δ-5.0). The analogous-PMe₃ adduct 6 was formed in a similar manner and has similar spectroscopic properties. These results supported the characterization of 4 as a 2,1 insertion product.

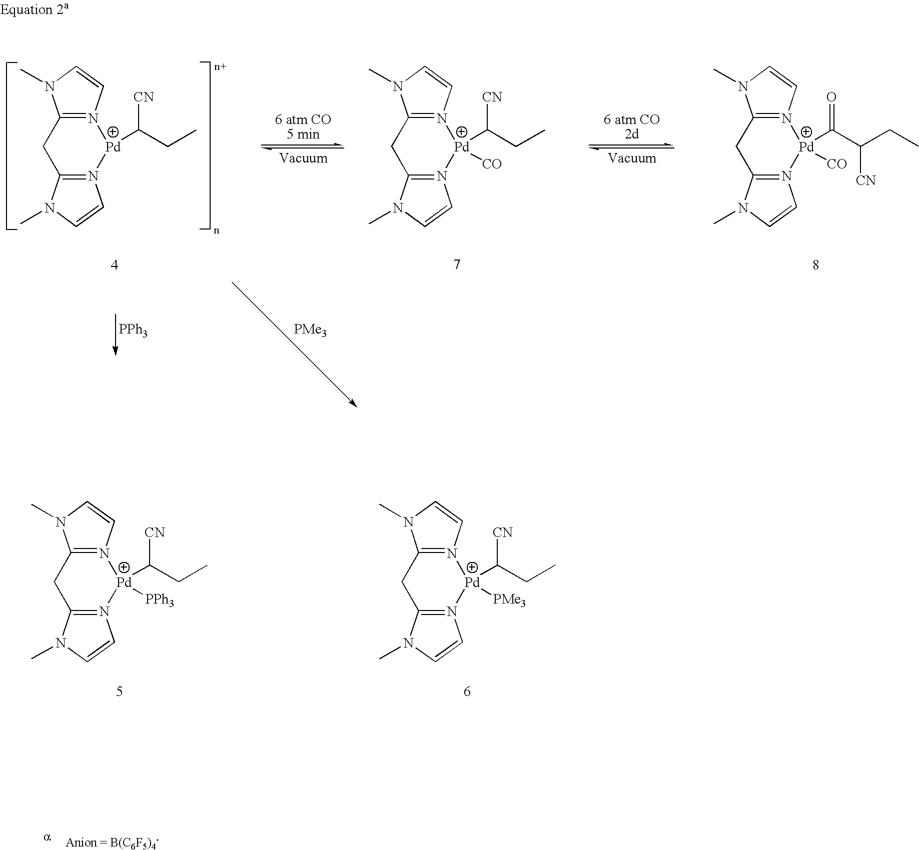

The oligomeric cation 4 also reacted with CO (6,atm, 23° C.) in the course of 5 min to give the CO adduct (bim)Pd{CH(CN)CH₂CH₃}(CO)⁺ (7). The ¹H— and COSY-NMR spectra demonstrated that 7 contained an O-cyanopropyl ligand. (In the presence of excess [HNMe₂Ph][B(C₆F₅)₄] the imidazole ¹H-NMR resonance of the complex 7 showed a slight high-field shift at δ 7.19 (<0.08 ppm) and the ¹³C-NMR resonance of the PdCH(CN) methine showed a slight high-field shift at δ 16.4 (<0.7 ppm). These effects were attributed to the partial protonation of the cyanide group of 7 by HNMe₂Ph⁺, which was confirmed by comparison experiments with the addition of an HNMe₂Ph⁺ or NMe₂Ph excess. To ensure that the system contained no excess HNMe₂Ph⁺, a slight excess (10%) of (bim)PdMe₂ (1) can be used in the activation process.) The ¹³C-NMR resonance for the coordinated CO appeared at δ 174, a similar value to that with related compounds, such as (bim)Pd{C(═O)CH₃}(CO)⁺ (δ 173). The CO coordination was reversible. 4 was obtained by stripping off the CO in vacuo.

The CO adduct 7 was converted slowly (2 days) at 23° C. with CO insertion into an equilibrium mixture of 7 and the CO insertion product (bim)Pd{C(═O)CH—(CN)—CH₂CH₃)}(CO)⁺ (8). The equilibrium constant for the CO insertion measured over a P_{CO} range of 4 to 20 atm was K_{eq} =[8][7]⁻¹ P_{CO}⁻¹=0.050(2) atm⁻¹ at 23° C. At a CO pressure of 6 atm CO, a mixture of 7 and 8 in a ratio of approximately 3/1 forms, while at 20 atm CO a 1/1 mixture formed.

The complex 8 was characterized by means of ¹H-, ¹³C-, ¹⁹F- and COSY-NMR. The ¹³C-Pd{C(═O)CH(CN)Et acyl resonance appeared at δ 213, a similar value to that for the acyl resonance in the analogous acetyl complex (bim)Pd{C(═O)CH₃}(CO)⁺ (δ217). The ¹³C-Pd{C(═O)CH(CN)Et} methine resonance appeared at δ 56.4 and, as expected on the basis of the adjacent carbonyl group, showed a considerable low-field shift (approx. 40 ppm) with respect to the corresponding resonances of 5-7. (The experimentally determined ¹³C-Pd{C(═O)CH(CN)Et} methine resonance (δ 56.4) agreed quite well with the value estimated for CH₃C(═O)CH(CN)Et (δ 48.1) using conventional additive rules for the chemical compound in ¹³C-NMR. See Breitmaier, E.; Voelter, W. Carbon-13 NMR, 3rd ed.; VCH Verlag: Weinheim, Germany, 1987; p. 313-325.) The ¹H-NMR resonance of the Pd{C(═O)CH(CN)Et} methine appeared at δ 3.51 (dd) and, because of the adjacent carbonyl group, showed a low-field shift by approx. 1.7 ppm with respect to the corresponding resonances of 5 and 6 and by 0.7 ppm with respect to the corresponding resonance of 7. For comparison, the methine resonance for CH₃C(═O)CH(CN)Et of δ 3.70 is mentioned. These allocations were confirmed by experiments with ¹³Co. The ¹H-NMR resonance of the Pd{³C(═O)CH(CN)Et} methine showed, on the basis of the marked carbonyl group, an additional coupling. (An unambiguous simulation of the ¹H-NMR resonance of the Pd{¹³C(═O)CH(CN)Et} methine to determine ²J_{CH} was not possible since the appearance of the simulated methine resonance was extremely sensitive with respect to the allocated chemical shifts for the diastereotopic CH₂ hydrogen, which couldnot be obtained because of the overlapping of these resonances with the corresponding resonances of 7. This complication underlined that the Pd{¹³C(═O)CH(CN)CH₂CH₃} spin system was second order on the basis of the small difference in the chemical shifts of the diastereotopic methylene hydrogen. However, if it was assumed that the chemical shifts of the methylene protons are δ 1.92 and 1.91, the Pd{¹³C(═O)CH(CN)Et} methine resonance was defined as ddd (J_{HH}=13.2, 0.8, ²J_{CH}=6.6). The ²J_{CH} value determined in this manner agreed with a C(═O)CH coupling).

By stripping off CO in vacuo, 4 was obtained, which confirms that the CO insertion was also reversible. For comparison, it may be stated that the CO insertion proceeded much faster with (bim)Pd(Me)(CO)⁺ (<1 min at 23° C., approx. 1 atm) and gives (bim)Pd{C(═O)CH₃}(CO)⁺ quantitatively and irreversibly. The CO insertion was thus inhibited by the presence of the α-CN substituent in (bim)Pd {CH(CN)—CH₂CH₃} (CO)⁺, but was not prevented completely.

### CONCLUSIONS

The (bim)PdMe⁺ cation formed the AN adduct (bim)Pd(Me)(NCCH═CH₂)⁺ with N-bonded AN. However, this species readily rearranged into the 2,1-insertion product (bim)Pd{CH(CN)CH₂CH₃}⁺, presumably by formation and insertion of the π complex (bim)PdMe(η²-C,C-AN)⁺. The (bim)Pd{CH(CN)CH₂CH₃}⁺ cation formed robust oligomeric [(bim)Pd{CH(CN)CH₂CH₃}]ₙⁿ⁺ species, which were characterized by ESI-MS. Although the structures of the [(bim)Pd{CH(CN)—CH₂CH₂)}]ₙⁿ⁺ oligomers were not determined, the Pd units were probably linked via Pd—CHEtCN—Pd bridges. The reaction of [(bim)Pd{CH(CN)CH₂CH₃}]ₙⁿ⁺ with PMe₃, PPh₃ or CO gave monomeric (bim)Pd{CH(CN)CH₂CH₃}(L)⁺ adducts. However, the [(bim)Pd{CH(CN)CH₂CH₃}]ₙⁿ⁺ oligomers were not broken open by CH₃CN, THF and ethylene. The CO complex (bim)Pd{CH(CN)CH₂CH₃}(CO)⁺ was converted by slow reversible CO insertion into (bim)Pd{C(═O)CH(CN)CH₂CH₃}(CO)⁺. The CO insertion was inhibited by the presence of the α-cyano substituent, but not prevented.

All work was carried out under N₂ or in vacuo using conventional Schlenk techniques or in a dry box filled with nitrogen, unless noted otherwise. Chlorinated solvents and acrylonitrile (AN) were distilled over CaH₂ and stored in vacuo before use. PMe₃ was obtained from Aldrich and dried over a 4-Å molecular sieve. PPh₃, CO and ¹³CO were obtained from Aldrich and used as obtained. [HNMe₂Ph][B(C₆F₅)₄] was obtained from Boulder Scientific and used as obtained. (bim)PdMe₂ (1) (bim ═CH₂(N-Me-imidazole)₂) was prepared in accordance with instructions from the literature as already described by Byers, P. K.; Canty, A. L. in Organometallics 1990, 9, 210.

¹H and ¹⁹F NMR spectra were recorded in closed tubes on a Bruker AMX-500 spectrometer at ambient temperature, unless noted otherwise. The chemical shifts in the ¹H and ¹³C spectra are stated with respect to Me₄Si and were determined using the residual solvent signals as the standard. For the chemical shifts in the ¹⁹F and ³¹P spectra, undiluted CFCl₃ and H₃PO₄ respectively served as the external standard. The coupling constants are stated in Hertz. ESI-MS experiments were carried out with an BP series 1100MSD instrument with direct intake via a syringe pump (approx. 10⁻⁶ M solutions). In all cases a good agreement was found between the isotope patterns observed and those calculated.

NMR spectra of ionic compounds contain B(C₆F₅)₄ resonances at the positions of the free anion. ¹³C{H}-NMR (CD₂Cl₂, 23° C.): δ 148.5 (dm, J=234, C2), 138.6 (dm, J=246, C4), 136.6 (dm, J=243, C3), the ipso-C₆F₅ signal was not observed. ¹⁹F-NMR (CD₂Cl₂, 23° C.): δ-133.2 (br s, 2F, Fₒ), -163.7 (t, J=23, 1F, Fₚ), −167.6 (t, J=19, 2F, Fₘ). ¹³C{¹H}-NMR (CD₂Cl₂, −60° C.): δ 147.5 (dm, J=241, C2), 137.8 (dm, J=238, C4) 135.8 (dm, J=249, C3), the ipso-C₆F₅ signal was not observed. ¹⁹F-NMR (CD₂Cl₂, −60° C.): δ-133.7 (br s, 2F, Fₒ), −163.0 (t, J=23, 1F, Fₚ), −167.0 (t, J=19, 2F, Fₘ).

NMR data for free NMe₂Ph: ¹H-NMR (CD₂Cl₂, 23° C.): δ 7.20 (m, 2H, ortho-Ph), 6.72 (m, 2H, meta-Ph), 6.67(t, J=7.3, 1H, para-Ph), 3.03 (s, 6H, CH₃). ¹³C{¹H}-NMR (CD₂Cl₂, 23° C.): δ 151.1 (s, ipso), 129.3 (s, C2), 116.6 (s, C4), 112.8 (s, C3), 40.7 (s, CH₃). ¹H-NMR (CD₂Cl₂, −60° C.): δ 7.18 (m, 2H, ortho-Ph), 6.67 (m, 2H, meta-Ph), 6.63 (t, J=7.3, 1H, para-Ph), 2.88 (s, 6H, CH₃). ¹³C{¹H}-NMR(CD₂Cl₂, −60° C.): 6150.2 (s, ipso), 128.7 (s, C2), 115.8 (s, C4), 111.9 (s, C3), 40.3 (s, CH₃).

NMR data for free AN: ¹H-NMR (CD₂Cl₂, 23° C.): δ 6.21 (d, J=17.9, 1H, H_{cis}), 6.07 (d, J=12.0, 1H, Hₜᵣₐₙₛ), 5.67 (dd, J=17.9, 12.0, 1H, Hᵢₙₜ). ¹³C{¹H}-NMR. (CD₂Cl₂, 23° C.): δ 138.0 (s, terminal vinyl-C), 117.3 (s, —CN), 108.2 (s, internal vinyl-C). ¹H-NMR (CD₂Cl₂, −60° C.): δ 6.24 (d, J=17.9, 1H, H_{cis}), 6.09 (d, J=12.0, 1H, Hₜᵣₐₙₛ), 5.69 (dd, J=17.9, 12.0, 1H, Hᵢₙₜ). ¹³C{¹H}-NMR (CD₂Cl₂, −60° C.): δ 138.1 (s, terminal vinyl-C), 117.3 (s, —CN), 107.2 (s, internal vinyl-C).

[(bim)PdMe(NMe₂Ph)][B(C₆F₅)₄] (2). (bim)PdMe₂ (1) (4.0 mg, 0.013 mmol) and [HNMe₂Ph][B(C₆F₅)₄] (10.0 mg, 0.013 mmol) were introduced into an NMR tube, after which CD₂Cl₂ (0.6 ml) was transferred into the tube at −78° C. by means of a vacuum. The tube was shaken vigorously, which resulted in a pale yellow solution. The tube was kept at −78° C. until it was transferred at −60° C. into the NMR probe. The NMR spectra showed the quantitative formation of 2. ¹H-NMR (CD₂Cl₂, −60° C.): δ 7.85 (d, J=8.0, 2H, ortho-H of coordinated NMe₂Ph), 7.44 (t, J=7.8, 2H, meta-H of coordinated NMe₂Ph), 7.30 (t, J=7.4, 1H, para-H of coordinated NMe₂Ph), 6.89 (s, 1H, imidazole-H), 6.88 (s, 1H, imidazole-H), 6.59 (s, 1H, imidazole-H), 4.98 (s, 1H, imidazole-H), 4.13 (s, 2H, CH₂), 3.66 (s, 3H, imidazole-N-Me), 3.58 (s, 3H, imidazole-N-Me), 2.92 (s, 6H, coordinated NMe₂Ph), 0.76 (s, 3H, PdMe). ¹³C{¹H}-NMR (CD₂Cl₂, −60° C.): δ 152.9 (s, Cl of coordinated NMe₂Ph), 141.8 (s, imidazole-C2), 140.7 (s, imidazole-C2), 129.1 (s, C2 of coordinated NMe₂Ph), 127.5 (s, C4 of coordinated NMe₂Ph), 126.9 (s, imidazole-C4), 125.6 (s, imidazole-C4), 121.9 (s, meta-C of coordinated NMe₂Ph), 121.5 (s, imidazole-C5), 121.4 (s, imidazole-C5), 52.9 (s, coordinated NMe₂Ph), 34.3 (s, imidazole-N-Me), 33.7 (s, imidazole-N-Me), 22.5 (s, CH₂), 2.1 (s, PdMe).

[(bim)PdMe(NCCH═CH₂)][B(C₆F₅)₄](3). An NMR tube with a solution of [(bim)PdMe(NMe₂Ph)][B(C6F₅)₄] (2) (0.013 mmol, prepared in situ as described above) in CD₂Cl₂ (0.6 ml) was cooled to −196° C. and an excess of acrylonitrile (0.195 mmol) was added by means of vacuum transfer. The tube was allowed to come to −78° C. and was shaken vigorously, which resulted in a pale yellow solution. The tube was kept at −78° C. until it was transferred at −60° C. into the NMR probe. The ¹H-NMR spectrum showed the quantitative formation of [(bim)PdMe(NCCH₂═CH₂)][B(C₆F₅)₄] (3). Resonances were moreover observed for free NMe₂Ph. The exchange between free and coordinated AN is slow at −60° C. on the NMR time-scale. ¹H-NMR (CD₂Cl₂, −60° C.): δ 6.99 (d, J=1.2, 1H, imidazole-H), 6.97 (d, J=1.2, 1H, imidazole-H), 6.92 (d, J=1.4, 1H, imidazole-H), 6.86 (d, J=1.2, 1H, imidazole-H), 6.55 (d, J=17.9, 1H, Hₜᵣₐₙₛ, of coordinated AN), 6.43 (d, J=12.0, 1H, H_{cis} of coordinated AN), 5.93 (dd, J=17.9, 12.0, 1H, Hᵢₙₜ of coordinated AN), 4.08 (s, 2H, CH₂), 3.71 (s, 3H, imidazole-N-Me), 3.68 (s, 3H, imidazole-N-Me), 0.75 (s, 3H, PdMe). ¹³C{¹H}-NMR (CD₂Cl₂, −60° C.): δ 143.0 (s, terminal vinyl-C of coordinated AN), 140.1 (s, imidazole-C2), 139.0 (s, imidazole-C2), 126.1 (s, imidazole-C4), 125.6 (s, imidazole-C4), 122.1 (s, imidazole-C5), 121.8 (s, imidazole-C5), 119.2 (s, —CN of coordinated AN), 105.7 (s, internal vinyl-C of coordinated AN), 34.6 (s, imidazole-N-Me), 33.7 (s, imidazole-N-Me), 22.7 (s, CH₂), −2.7 (s, PdMe).

[(bim)Pd{CH(CN)CH₂CH₃}ₙⁿ⁺ (4). An NMR tube with a solution of [(bim)PdMe-(NCCH₂═CH₂)][B(C₆F₅)₄] (3) (0.013 mmol, prepared in situ as described above) and an excess of AN (0.182 mmol) in CD₂Cl₂ (0.6 ml) was kept at 23° C. and checked by means of NMR from time to time. The NMR signals associated with (bim)PdMe(NCCH₂═CH₂)^{+l (}3) disappeared after 12 h. By stripping off the volatile constituents in vacuo, a pale yellow solid was obtained, which was dissolved again in CD₂Cl₂ (0.6 ml). According to NMR and ESI-MS analyses, [(bim)Pd{CH(CN)CH₂CH₃}]ₙⁿ⁺ species (4) were present. The NMR yield for 4 is 90%. ¹H-NMR (CD₂Cl₂) main resonances: δ 7.10 (d, J=1.4, imidazole-H), 7.05 (d, J=1.4, imidazole-H), 7.03 (d, J=1.4, 1H, imidazole-H), 7.02 (d, J=1.4, 1H, imidazole-H), 6.99 (d, J=1.4, 1H, imidazole-H), 6.93. (d, J=1.4, 1H, imidazole-H), 6.91 (d, J=1.4, 1H, imidazole-H), 6.87 (d, J=1.4, 1H, imidazole-H), 6.86 (d, J=1.4, 1H, imidazole-H), 6.83 (br s, 2H, imidazole-H), 6.82 (d, J=1.4, 1H, imidazole-H), 4.14 (s, 2H, CH₂), 4.12 (s, 2H, CH₂), 4.09 (s, 2H, CH₂), 3.76 (s, 3H, imidazole-N-Me), 3.75 (s, 3H, imidazole-N-Me), 3.74 (s, 3H, imidazole-N-Me), 3.69 (s, 3H, imidazole-N-Me), 3.68 (s, 6H, imidazole-N-Me), 2.49 (br m, 3H, PdCH(CN)), 2.22 (m, 1H, PdCH(CN)CH₂), 2.13 (m, 1H, PdCH(CN)CH₂), 2.05 (m, 2H, PdCH(CN)CH₂), 1.90 (m, 1H, PdCH(CN)CH₂), 1.78 (m, 1H, PdCH(CN)—CH₂), 1.24-1.15 (m, 9H, PdCH(CN)CH₂CH₃). Main cations in ESI-MS: m/z 350.1 (C₁₃H₁₈N₅Pd⁺, (bim)Pd{CH(CN)CH₂CH₃}⁺) and (C₂₆H₃₆N₁₀Pd²⁺, [(bim)Pd{CH(CN)CH₂CH₃}]₂²⁺), m/z 865.2 (C₆₃H₅₄N₁₅BF₂₀Pd₃²⁺ [(bim)Pd {CH(CN)CH₂CH₃}]₃³⁺[B(C₆F₅)₄]⁻).

[(bim)Pd{CH(CN)CH₂CH₃}(PPh₃)][B(C₆F₅)₄] (5). Solid PPh₃ (3.3 mg, 0.013 mmol) was introduced into an NMR tube with solid [(bim)Pd{CH(CN)—CH₂CH₃}]ₙⁿ⁺ (4, B(C₆F₅)₄⁻ salt, 0.013 mmol, prepared in situ as described above. The tube was evacuated, after which CD₂Cl₂ (0.6 ml) was added by vacuum transfer at −78° C. The tube was shaken vigorously, which resulted in a dirty-white solution, and then allowed to come to 23° C. After 5 min the NMR spectra showed the quantitative formation of (bim)Pd{CH(CN)CH₂CH₃}(PPh₃)+(5). ¹H-NMR (CD₂Cl₂: δ 7.68 (m, 7H, ortho-PPh₃ and imidazole-H), 7.57 (m, 3H, para-PPh₃), 7.48 (m, 6H, meta-PPh₃), 7.02 (s, 1H, imidazole-H), 6.40 (d, J=1.5, 1H, imidazole-H), 5.71 (d, J=1.5, 1H, imidazole-H), 4.24 (s, 2H, bridging CH₂), 3.78 (s, 3H, imidazole-N-Me), 3.62 (s, 3H, imidazole-N-Me), 1.72 (ddd, J_{HH}=12.9, 8.5; J_{HP}=6.9, 1H, PdCH(CN)CH₂), 1.31 (m, 1H, PdCH(CN)CH₂), 1.28 (m, 1H, PdCH(CN)CH₂), 0.67 (t, J=7.3, 3H, PdCH(CN)CH₂CH₃). ¹³C{¹H}-NMR (CD₂Cl₂): δ 141.6 (s, imidazole-C2), 141.0 (s, imidazole-C2), 134.6 (d, J=11, ortho-PPh₃), 132.4 (d, J=3, para-PPh₃), 129.6 (d, J=10, meta-PPh₃), 128.0 (s, imidazole-C4), 127.3 (s, imidazole-C4), 123.8 (s, PdCH(CN)), 122.6 (d, J_{CP}=3, imidazole-C5), 122.0 (s, imidazole-C5), 34.6 (s, imidazole-N-Me), 34.3 (s, imidazole-N-Me), 25.5 (s, PdCH(CN)CH₂), 23.2 (s, CH₂), 15.2 (s, PdCH(CN)CH₂CH₃), 13.2 (d, J_{CP}=4, PdCH(CN)CH₂). ³¹P{¹H}-NMR (CD₂Cl₂): δ 35.1 (s, PPh₃. ESI-MS: (bim)Pd{CH(CN)CH₂CH₃}(PPh₃)+(5) calculated: m/z 612.1, found: 612.0. B(C6F₅)₄ calculated: m/z 679.0, found: 678.7.

[(bim)Pd{CH(CN)CH₂CH₃}(PMe₃)][B(C₆F₅)₄] (6): An NMR tube with a solution of [(bim)Pd{CH(CN)CH₂CH₃}]ₙⁿ⁺ (4, B(C₆F₅)₄— salt, 0.013 mmol, prepared in situ as described above) in CD₂Cl₂ (0.6 ml) was cooled to −196° C., after which PMe₃ (0.014 mmol) was condensed in via a gas flask. The tube was allowed to come to 23° C. and was shaken vigorously, which resulted in a dirty-white solution. After 5 min at 23° C. the NMR spectra showed the quantitative formation of (bim)Pd{CH(CN)CH₂CH₃}(PMe₃)⁺ (6). ¹H-NMR (CD₂Cl₂): δ 7.50 (s, 1H, imidazole-H), 6.98 (s, 1H, imidazole-H), 6.94 (d, J=1.4, 1H, imidazole-H), 6.86 (d, J=1.5, 1H, imidazole-H), 4.17 (s, 2H, CH₂), 3.75 (s, 3H, imidazole-N-Me), 3.72 (s, 3H, imidazole-N-Me), 1.93 (m, 1H, PdCH(CN)CH₂), 1.53 (d, J=10.6, 9H, Pd-PMe₃), 1.46 (m, 2H, PdCH(CN)CH₂), 1.03 (t, J=7.3, 3H, PdCH(CN)CH₂CH₃). ¹³C{¹H}-NMR (CD₂Cl₂): δ 142.2-(s, imidazole-C2), 141.7 (s, imidazole-C2), 128.6 (s, imidazole-C4), 126.8 (s, imidazole-C4), 123.8 (s, PdCH(CN)), 122.8 (s, imidazole-C5), 122.6 (d, JCP=4, imidazole-C5), 34.5 (s, imidazole-N-Me), 34.4 (s, imidazole-N-Me), 25.6 (s, PdCH(CN)CH₂), 23.2 (s, CH₂), 15.6 (s, PdCH(CN)CH₂CH₃), 14.8 (d, J_{CP}=35, PMe₃), 9.0 (d, JCP=6, PdCH(CN)CH₂). ³¹P{¹H}-NMR (CD₂Cl₂): δ-5.3 (s, PMe₃). ¹H-¹H—COSY key correlations: δ 1.93 (PdCH(CN)CH₂/δ 1.46 (PdCH(CN)CH₂); δ 1.46 (PdCH(CN)CH₂)/δ 1.03 (PdCH(CN)CH₂CH₃). ESI-MS: (bim)Pd{CH(CN)CH₂CH₃}(PMe₃)+(6) calculated: m/z 426.1, found: 426.0. B(C₆F₅)₄⁻ calculated: m/z 679.0, found: 678.7.

[(bim)Pd{CH(CN)CH₂CH₃}(CO)][B(C₆F₅)₄] (7). An NMR tube with a solution of [(bim)Pd{CH(CN)CH₂CH₃}]ₙⁿ⁺ (4) (B(C₆F₅)₄ salt, 0.013 mmol, prepared in situ as described above) in CD₂Cl₂ (0.6 ml) was cooled to −196° C. and CO (0.558 mmol, corresponding to approx. 6.7 atm at 23° C.) was added. The tube was allowed to come to 23° C., which resulted in a dirty-white solution. After 5 min the NMR spectra showed the quantitative formation of (bim)Pd{CH(CN)₉H₂CH₃}(CO)+(7). ¹H-NMR (CD₂Cl₂): δ 7.19 (d, J=1.4, 1H, imidazole-H), 7.14 (d, J=1.6, 1H, imidazole-H), 7.09 (d, J=1.5, 1H, imidazole-H), 7.00 (d, J=1.5, 1H, imidazole-H), 4.19 (A part of an AB pattern, J_{AB}=18.0, 1H, CH₂), 4.16(B part of an AB pattern, J_{AB}=18.0, 1H, CH₂), 3.80 (s, 3H, imidazole-N-Me), 3.77 (s, 3H, imidazole-N-Me), 2.83 (m, 1H, PdCH(CN(CH₂), 1.92 (m, 2H, PdCH(CN)CH₂), 1.21 (t, J=7.3, 3H, PdCH(CN)CH₂CH₃). ¹³C{¹H}-NMR (CD₂Cl₂): δ 174.2 (s, Pd-CO), 141.4 (s, imidazole-C2), 140.1 (s, imidazole-C2), 128.9 (s, imidazole-C4), 125.8 (s, imidazole-C4), 124.2 (s, PdCH(CN)CH₂), 124.0 (s, imidazole-C5), 123.8 (s, imidazole-C5), 35.1 (s, imidazole-N-Me), 34.6 (s, imidazole-N-Me), 29.5 (s, PdCH(CN)CH₂), 23.2 (s, CH₂), 16.4 (s, PdCH(CN)CH₂), 15.5 (s, PdCH(CN)CH₂CH₃). ¹H-¹H-COSY key correlations: δ 2.83 (PdCH(CN)CH₂)/δ 1.92 (PdCH(CN)CH₂); δ 1.92 (PdCH(CN)CH₂)/1.21 (PdCH(CN)CH₂CH₃). ¹H-¹³C-HMQC key correlations: δ 2.83 (PdCH(CN))/δ 16.4 (PdCH(CN)); δ 1.92 (PdCH(CN)CH₂)/δ 29.5 (PdCH(CN)CH₂); δ 1.21 (PdCH(CN)CH₂CH₃)/δ 15.5 (PdCH(CN)CH₂CH₃). By stripping off the volatile constituents in vacuo, a pale yellow solid was obtained. The solid was dried in vacuo for 10 min and dissolved again in CD₂Cl₂ (0.6 ml). The NMR spectra showed the complete conversion of (bim)Pd{CH(CN)CH₂CH₃}(CO)⁺ into [(bim)Pd{CH(CN)CH₂CH₃}]ₙ⁺ (4).

[(bim)Pd{C(═O)CH(CN)CH₂CH₃}(CO)][B(C₆F₅)₄] (8). An NMR tube with a solution of [(bim)Pd {CH(CN)CH₂CH₃} (CO)] [C(C₆F₅)₄] (7) (0.013 mmol, prepared in situ as described above) in CD₂Cl₂ (0.6 ml) and CO (0.558 mmol, corresponding to approx. 6.7 atm at 23° C.) was kept at 23° C. and checked by means of NMR from time to time. The spectra showed that 7 was converted slowly into (bim)Pd{C(═O)CH(CN)CH₂CH₃}(CO)⁺ (8). After 2 days the ratio of [7]/[8] reached a constant equilibrium value of 3/1. In a similar experiment with 20 atm CO, the reactant/product equilibrium ratio was 1/1. The equilibrium constant K_{eq}=[(bim)Pd {C(═O)CH(CN)CH₂CH₃} (CO)⁺]*[(bim)Pd {CH(CN)CH₂CH₃}(CO)⁺]⁻¹*P_{CO}⁻¹=0.050 (2) atm⁻¹ was determined by six experiments with P_{CO} in the range from 4 to 20 atm. Data for (bim)Pd{C(═O)CH(CN)CH₂CH₃)}(CO)⁺: ¹H-NMR (CD₂Cl₂): δ 7.07 (d, J=1.6, 1H, imidazole-H), 7.06 (d, J=1.7, 1H, imidazole-H), 6.91 (d, J=1.8, 1H, imidazole-H), 6.83 (d, J=1.8, 1H, imidazole-H), 4.27 (s, 2H, CH₂), 3.78 (s, 3H, imidazole-N-Me), 3.76 (s, 3H, imidazole-N-Me), 3.51 (m, 1H, Pd{C(═O)CH(CN)}), 1.91 (m, 2H, Pd{C(═O)CH(CN)CH₂}), 1.07 (t, J=7.5, 3H, Pd{C(═O)CH(CN)CH₂CH₃}). ¹³C{¹H}-NMR (CD₂Cl₂): δ 212.8 (s, Pd{C(═O)CH(CN)}), 172.4 (s, Pd-CO), 142.0 (s, imidazole-C2), 140.8 (s, imidazole-C2), 128.6 (s, imidazole-C4), 128.1 (s, imidazole-C4), 127.2 (s, imidazole-C5), 123.8 (s, imidazole-C5), 123.3 (s, CH(CN)), 56.4 (s, CH(CN)CH₂), 35.1 (s, imidazole-N-Me), 34.5 (s, imidazole-N-Me), 23.2 (s, CH₂), 22.9 (s, CH(CN)CH₂), 11.3 (s, CH₂CH₃). ¹H-¹H-COSY key correlations: δ 3.51 (Pd{C(═O)CH(CN)})/δ 1.91 (Pd{C(═O)CH(CN)CH₂}); δ 1.91 (Pd{C(═O)CH(CN)CH₂})/δ 1.07 (Pd{C(═O)CH(CN)CH₂CH₃}). ¹H-¹³C-HMQC key correlations: δ 3.51 (Pd{C(═O)CH(CN)})/δ 56.4 (Pd{C(═O)CH(CN)}); δ 1.91 (Pd{C(═O)CH(CN)CH₂}) δ 22.9 (Pd{C(═O)CH(CN)CH₂}); δ 1.07 (Pd{C(═O)CH(CN)CH₂CH₃})/δ 11.3 (Pd{C(═O)CH(CN)CH₂CH₃}). By stripping off the volatile constituents in vacuo, a pale yellow solid was obtained. The solid was dried in vacuo for 10 min and dissolved again in CD₂Cl₂ (0.6 ml). The NMR spectra showed complete conversion of both 7 and 8 into [(bim)Pd{CH(CN)CH₂CH₃}]ₙⁿ⁺ (4).

### Example 2

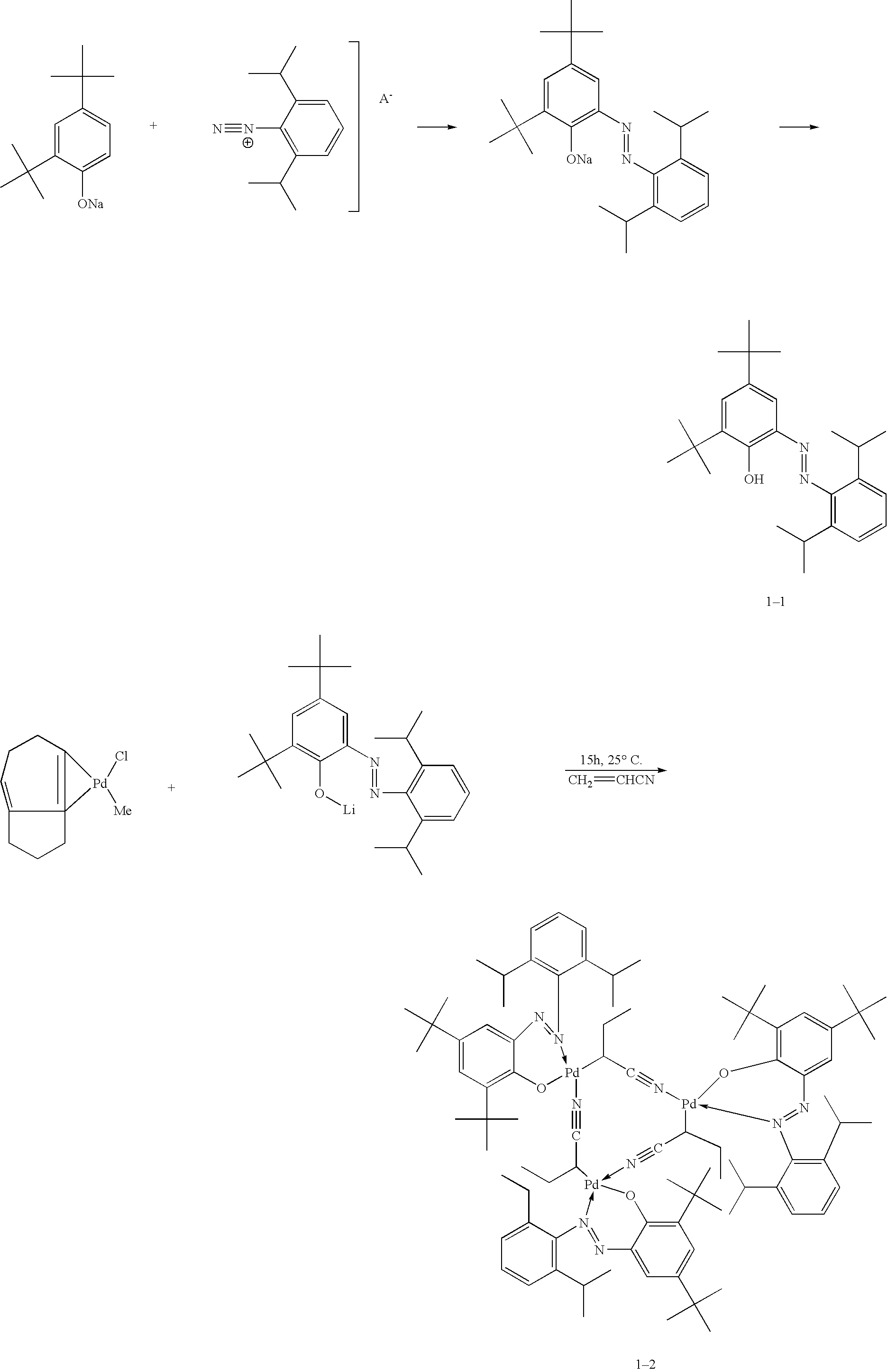

Preparation of the [N₂,O] ligand (1-1). The ligands were obtained by a coupling reaction of the diazonium salt with the corresponding phenols. The diazonium salt was prepared by reaction of 2,6-diisopropylaniline (20 mmol) with isoamyl nitrite (2.9 g, 3.4 ml, 25 mmol) and BF₃*OEt₂ (3.1 g; 2.8 ml; 22 mmol) in methylene chloride (200 ml) at −10° C. in the course of 60 min. After filtration of the diazonium salt (water-pump vacuum) in the cold at −10 to −20° C., this was then suspended in THF (50 ml) at −20° C. and the suspension was introduced into a solution of phenol (20 mmol) (dissolve phenol in as little ethanol as possible and add NaOH (10 g, 250 mmol) in 100 ml water) at −20° C. (stirring for 1, h). The reaction solution was then warmed to 25° C. with thorough stirring and stirred for a further 15 h. For working up, hexane was added, the mixture was mixed intimately with dilute HCl and then washed to pH 7 with water and the aqueous phase was separated off. After drying the organic phase over Na₂SO₄, the dyestuff was chromatographed over silica gel with hexane/methylene chloride 3/1. A purified product was obtained by crystallization from methanol at −20° C.

Anal. Calc. for C₂₆H₃₈N₂O (394.59): C, 79.14; H, 9.71; N, 7.10; found: C, 79.0; H, 10.4; N, 6.9. M.p.: 82° C. ¹H-NMR in CDCl₃, [δ]: 1.20 (d, 12H, ¹³J_{HH}=7.8 Hz, CH₃; i-Pr), 1.37 (s, 9H, CH₃, t-Bu), 1.49 (s, 9H, CH₃, t-Bu), 3.05 (sp, 2H, ³J_{HH}=7.8 Hz, CH; i-Pr); 7.25-7.32 (m, 3H, CH, Ar), 7.50 (s, 1H, CH, Ar), 7.80 (s, 1H, CH, Ar), 13.2 (1H, OH). ¹³C{¹H}-NMR in CDCl₃, [8]: 23.7 (CH₃, i-Pr), 27.9 (CH, i-Pr), 29.5 (CH₃, t-Bu), 31.4 (CH₃, t-Bu), 34.3 (C, t-Bu), 35.4 (C, t-Bu), 123.7 (CH, Ar), 127.7 (CH, Ar), 128.2 (CH, Ar), 128.6 (CH, Ar), 136.9 (C, Ar), 137.9 (C, Ar), 140.2 (C, Ar), 141.3 (C, Ar), 148.5 (C, Ar), 149.8 (C, Ar).

Conversion of the acid azo dyestuffs into the corresponding Li salt:

The azo dyestuff(14.2 mmol) was dissolved in 150 ml tetrahydrofuran and the solution was cooled to −78° C. Diethyl ether can also preferably be used if the azo dyestuff was sufficiently soluble. n-BuLi (2.7 M in heptane; 5.8 ml, 15.6 mmol) was then added dropwise and the reaction mixture was stirred at −78° C. for 1 h. After warming to 25° C., the solvent was removed and 60 ml n-hexane are added. The purified product was obtained by crystallization at −20° C. and can be further processed directly.

2,1 Insertion of Acrylonitrile:

{[N₂,O]PdCH(CN)CH₂CH₃}₃ (1-2). The Li salt of the azo compound (1.5 mmol) was taken up in acrylonitrile (10 ml). (COD)Pd(Me)Cl (COD=cis,cis-1,5-cyclooctadiene) (1.5 mmol) was then dissolved in acrylonitrile (5 ml) and the solution was introduced at 0° C. The suspension obtained was stirred at 25° C. for 15 h. After removal of all the volatile constituents the residue was dissolved in toluene and insoluble constituents are filtered off. The solvent was removed and hexane was added. Crystallization at −20 to −78° C.

Anal. Calc. for C₉₀H₂₉N₉O₃Pd₃ C, 63.43; H, 7.63; N, 7.40; O, 2.82; Pd, 18.73 found.: C, 63.5; H, 7.8; N, 7.2. MS (FD)[%]: 1703 (100, M⁺), 1137 (20, dimer], 567[20, monomer]. IR: 2235 (s, v_{(C≡N)}). X-ray structure analysis showed the trimerization product of the 2,1 insertion of the acrylonitrile into the palladium-α-methylidene bond (FIG. 1).

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

1. Compounds of the formula (I) 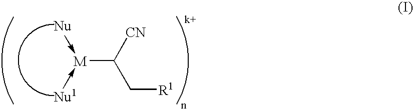
wherein
M is an element of the 4th to 12th group of the periodic table,
Nu is chosen from the group consisting of —P(R)₂, —N═P(R), —N═N(R), —C(R²)═P(R) and —C(R²)═N(R), wherin the coordination to M starts from the atom which carries the substituent R, and
R is chosen from the group consisting of hydrogen and C₁-C₂₄ substituted or unsubstituted hydrocarbon radicals, which optionally carry further heteroatoms, and wherein R can also form a ring with ∩, with R² or with the atom of Nu which does not form a coordinative bond to M,
R² is chosen from the group consisting of hydrogen and C₁-C₂₄ substituted or unsubstituted hydrocarbon radicals, which optionally carry further heteroatoms,
Nu¹ is chosen from the group consisting of —O—, ═N(R³) and ═P(R³), wherein if Nu¹ is —O—, no coordinative bond but a covalent bond to M is present,
R³ is chosen from the group consisting of hydrogen and C₁-C₂₄ hydrocarbons, which optionally carry further heteroatoms, and wherein R³ can also form a ring with ∩ or with the atom of Nu¹ adjacent to the double bond,
R¹ is chosen from the group consisting of C₁-C₂₄ substituted or unsubstituted hydrocarbon radicals and a polymer chain, wherein the polymer chain is built up from recurring units derived from ethylene, propylene, styrene, carbon monoxide, 1,3-butadiene, acrylates, acrylonitrile or mixtures of these monomers, and
n is an integer between 1 and 100, wherein for n 1 a donor atom D chosen from the group consisting of neutral donor compounds can stabilize the metal center, and
k is an integer between 0 and 100 and only in the case where Nu¹ is —O— is k=0,
∩ is a hydrocarbon group which in each case independently of one another forms a covalent single or multiple bond to Nu and to Nu¹, wherein both the bond to Nu and to Nu¹ are formed either from the same C atom of the hydrocarbon group or from two different C atoms of the hydrocarbon group, and wherein the hydrocarbon group is derived from alkyl, cycloalkyl, aryl, aralkyl and alkylaryl units and mixtures of these units, wherein the hydrocarbon group optionally carry further heteroatoms.

2. Process for the preparation of the compounds of the formula (I) according to claim 1, comprising the steps
a) providing a compound of the formula (II) 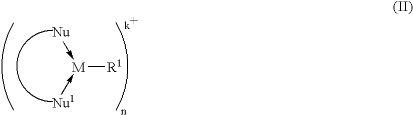
in which Nu, Nu¹, M, R¹, n and k have the same meaning as in claim 1 and
b) reacting the compound of the formula (II) with acrylonitrile in the temperature range from −200 to +200° C. and in the presence of a organic solvent.

3. Process according to claim 1, wherein the reaction of the compounds of the formula (II) with acrylonitrile comprises the
a) reacting compounds of the formula (II) with acrylonitrile in a temperature range from −200 to −60° C. to form the compounds of the formula (III) 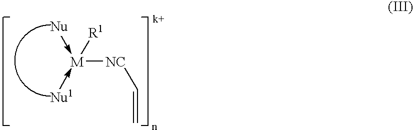
wherein Nu, Nu¹, M, R¹, n and k have the same meaning as in claim 1, and subsequent removing the organic solvent,
b) reacting compounds of the formula (III) with acrylonitrile at a temperature in the range from −200 to +200° C. and
c) monitoring the conversion of the compounds of the formula (III) into the compounds of the formula (I) by time-dependent NMR spectroscopy.

4. A process for the preparation of the complexes of the formula (IV) 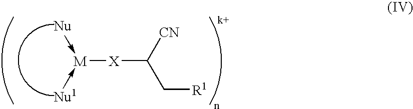
wherein Nu, Nu¹, M, R¹, n and k have the same meaning as in claim 1 and the recurring unit X is derived from one or more monomers chosen from the group consisting of carbon monoxide, ethene, 1,3-butadiene, styrol, 1-olefins, acrylonitrile, methacrylonitrile, fumaric acid dinitrile, alkyl acrylates, acrylic acid, sodium acrylate, fumaric acid, fumaric acid esters, maleic acid, maleic acid esters, maleic anhydride, alkyl vinyl ethers and mixtures of these monomers comprising reacting a compound according to claim 1 with a monomer chosen from the group consisting of carbon monoxide, 1-olefins, acrylonitrile, methacrylonitrile, fumaric acid dinitrile, alkyl acrylates, acrylic acid, sodium acrylate, fumaric acid, fumaric acid esters, maleic acid, maleic acid esters, maleic anhydride, alkyl vinyl ethers and mixtures of these monomers.
